(19) United States
(12) Patent Application Publication
(10) Pub. No.: US 2012/0169607 A1
(43) Pub. Date: Jul. 5, 2012

(54) APPARATUS AND ASSOCIATED METHODS

(75) Inventor: Johanna Maria TIITOLA, Helsinki (FI)

(73) Assignee: NOKIA CORPORATION, Espoo (FI)

(21) Appl. No.: 12/980,464

(22) Filed: Dec. 29, 2010

(51) Int. Cl. G06F 3/041

(52) U.S. Cl. 345/173

(57) ABSTRACT

Apparatus comprising at least one processor; and at least one memory including computer program code, the at least one memory and the computer program code configured to, with the at least one processor, cause the apparatus to perform the following: display a portion of a target area and a corresponding indicium on a touch screen when a scriber is not interacting with the touch screen, the displayed portion of the target area being offset from the corresponding indicium such that the indicia is still to be visible when a scriber interacts with the displayed portion of the target area; receive scriber input at the target area; and enable performance of a function associated with the target area based on the received scriber input.

### TECHNICAL FIELD

The present disclosure relates to the field of touch-sensitive screens, associated methods, computer programs and apparatus.

### BACKGROUND

Some electronic devices permit a user to input data by ‘typing’ on, or otherwise interacting with, a virtual keypad (e.g. using a stylus and touch sensitive pad). When users enter data in this manner, the user generally uses a scriber (e.g. a stylus or finger) to activate keys. Each key may be considered to be a region or target area of a touch screen associated with a particular function. For example, a user typing the letter “a” on a virtual QWERTY keypad would generally aim for the very centre of the key. This allows the maximum margin for error should the user's finger be slightly off-target.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising at least one processor; and

at least one memory including computer program code, the at least one memory and the computer program code configured to, with the at least one processor, cause the apparatus to perform the following: display a portion of a target area and a corresponding indicium on a touch screen when a scriber is not interacting with the touch screen, the displayed portion of the target area being offset from the corresponding indicium such that the indicia is still to be visible when a scriber interacts with the displayed portion of the target area; receive scriber input at the target area; and enable performance of a function associated with the target area based on the received scriber input.

Thus, as the user's finger approaches the centre of the “a” key, for example, the label/indicium ‘a’ is not obscured from the user's vision. This should obviate the difficulty for the user to know which key has been pressed.

The scriber may, for example, comprise a finger, a finger nail, a thumb or a stylus.

The touch screen may use stress, strain, conductivity, surface acoustic waves, capacitance and/or heat to determine the position and/or the pressure of the scriber with respect to the touch screen.

Each indicium may indicate/denote the nature of the function corresponding to that indicium (e.g. by using text and/or pictorial icon). The displayed portion of the target area may be considered to give the user a target for aiming the scriber at to activate the target area. A target area may be considered to be a selectable portion of the area of the touch screen associated with a particular function.

The offset between the displayed portion of the target area and the corresponding indicium may be considered to be the distance between the centre (and/or perimeter edges) of the displayed portion of the target area and the centre (and/or perimeter edges) of the corresponding indicium. The offset may be considered to be the displacement (i.e. encompassing distance and direction) between the centre (and/or perimeter edges) of the displayed portion of the target area and the centre (and/or perimeter edges) of the corresponding indicium. It will be appreciated that the offset distance and/or displacement may be such that the indicium does not obscure adjacent target areas, displayed portions of target areas and/or keys (e.g. those target areas and/or displayed portions which do not correspond to the indicium). The indicium may be considered to be positionally associated with the corresponding displayed portion of the target area.

The offset distance may be a predetermined absolute distance (e.g. between 2 mm and 15 mm). The offset distance may be a predetermined ratio of a screen dimension (e.g. between 2% and 5% of the screen height), a predetermined ratio of the target area size (e.g. between 5% and 200% of the target width), a predetermined ratio of the displayed portion of the target area (e.g. between 5% and 200% of the displayed portion of the target area), or a predetermined ratio of the indicium size (e.g. between 5% and 200% of the indicium height).

It will be appreciated that the displayed portion of the target area may represent a fraction of the target area or the whole of the target area (which is able to receive scriber input).

It will be appreciated that a target area may comprise an area of the touch screen which corresponds to a particular function, such that scriber input, received at the target area, may enable performance of the particular function.

Scriber input may comprise tapping the touch screen with the scriber, double tapping the touch screen with the scriber (this may be likened to double clicking with a mouse), dragging the scriber across the touch screen and/or exerting a pressure on the touch screen. Scriber input may comprise single-touch or multi-touch input.

The scriber input may generate data representing a contact action on a virtual keyboard (or other input interface). The contact action may be considered to comprise an initial contact location, a path along which contact with the touch-sensitive screen continues, and a final contact location at which contact of the scriber with the touch-sensitive screen is removed, forming an input stroke pattern according to the (recorded) contact action.

The apparatus may be configured such that the respective target areas/indicia provide for scriber input of characters (e.g. textual input), with the indicia indicating the particular character which can be input. The characters may include, for example, numbers, punctuation marks and/or letters of the Roman, Greek, Arabic and/or Cyrillic alphabets. The apparatus may be configured to enable input of Chinese or Japanese characters, either directly or via transcription methods such as Pinyin and/or Bopomofo (Zhuyin Fuhao). The apparatus may provide for a key input area in one or more of English, Chinese, Japanese, Greek, Arabic, Indo-European, Oriental and Asiatic language.

The apparatus may enable textual input methods wherein a user enters words by sliding a finger or stylus from letter to letter, lifting between words (drawing so-called “wordshapes”).

The apparatus may be configured to search a dictionary (e.g. a predictive text dictionary comprising a list of possible input words/phrases or other character strings) to find words/phrases/character strings wherein the initial letter corresponds with the target area of the initial contact location; the final letter corresponds with the target area of the final contact location; and/or the order of the letters have the same order as at least some of the letters corresponding to the target areas touched during the contact action.

The target area and corresponding indicium may be configured to be spatially distinct (or spatially separate) such that a scriber can interact with the touch screen at the corresponding indicium without inputting the function associated with the corresponding indicium.

The display may comprise a plurality of target areas and corresponding indicium wherein the apparatus is configured such that the respective target areas/indicia provide for scriber input of characters, with each indicium indicating the particular character which can be input.

The area occupied by the indicia may be positioned within the target area. The area occupied by the indicia may be positioned outside the target area. The area occupied by the indicia may be positioned within the displayed portion of the target area. The area occupied by the indicia may be positioned outside the displayed portion of the target area.

The display may comprise a plurality of target areas and corresponding indicia, and wherein the apparatus is configured such that the target areas/indicia represent an alphabet key input area. The display may comprise a plurality of target areas and corresponding indicia, and wherein the apparatus is configured such that the respective target areas/indicia represent an alphanumeric key input area. The display may comprise a plurality of target areas and corresponding indicia, and wherein the apparatus is configured such that at least one of the respective target areas/indicia represent a single function (e.g. a QWERTY key input area) or a plurality of functions (e.g. a reduced keypad such as a ITU-T E.161 keypad). The apparatus may be used for predictive text messaging, for disambiguating ambiguous key sequences and/or multi-tap text entry.

The apparatus may be configured such that the respective target areas/indicia provide for scriber input indicating the selection of an item from a menu, with the indicia indicating the particular items from the menu which can be selected. Menu items may correspond to one or more of single or multiple software applications, contacts, website favourites, previous calls, TV channels, settings, games, names, addresses and any other items.

The apparatus may be configured such that the respective target areas/indicia provide for scriber input indicating the selection of an icon, with each indicium indicating the particular icon (e.g. relating to a corresponding software application) which can be selected.

The apparatus may be configured such that a series of target functions can be selected by contacting the screen with the scriber in one continuous motion, wherein, during the continuous motion, the scriber touches each of the target areas corresponding to the series of target functions.

The apparatus may be configured to enable performance of a function associated with the target area and the corresponding indicium based on the received scriber input.

The apparatus may be configured such that the target indicium is associated with a target function. The apparatus may be configured to receive scriber input at the indicium and enable performance of a function associated with the indicium based on the received scriber input. The apparatus may be configured to associate a target area of a touch screen with each of one or more target functions, the touch screen configured to generate an input in response to a corresponding interaction of a scriber with the touch screen.

The apparatus may be configured such that one or more target indicium is displayed contiguous with or adjacent to the respective target area. The apparatus may be configured such that each of the one or more target indicia is displayed above, below or to the side of the respective target area. References to above, below or to the side may refer to the relative position with respect to the device (e.g. where the device has a top or bottom independent of its orientation with respect to the ground) or with respect to the ground (or gravity).

It will be appreciated that other embodiments may comprise physical buttons in place of or in addition to touch buttons/keys provided on a touch-screen.

The apparatus or processor may be incorporated into an electronic device. The apparatus may be an electronic device. The apparatus may comprise a touch screen interface for an electronic device or a module for an electronic device/display or a display of an electronic device. Examples of an electronic device include a portable electronic device, a laptop computer, a Satellite Navigation console, a desktop computer, a monitor, a mobile phone, a TV, a Smartphone, a personal digital assistant (PDA) and a digital camera.

The apparatus may be configured to allow adjustment of the offset (e.g. to accommodate users with large/small fingers or different sizes of scriber). The offset may be manually adjusted/preselected (e.g. by the user) and/or automatically adjusted by the apparatus (e.g. wherein the apparatus detects the size of the scriber, or according to the mode of the device).

The electronic device may provide one or more of audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a in-built digital camera), and gaming functions.

Transmission of data may be via a network (by signalling). The network may be, for example, the internet, a mobile phone network, a wireless network, LAN or Ethernet. The apparatus may comprise a transmitter and or receiver to interact with a network. The transmitter/receiver may comprise, for example, an antenna, an Ethernet port, a LAN connection, a USB port, a radio antenna, Bluetooth connector, infrared port, fibre optic detector/transmitter.

In a second aspect, there is provided a method comprising displaying a portion of the target area and a corresponding indicium on a touch screen when a scriber is not interacting with the touch screen, the displayed portion of the target area being offset from the corresponding indicium such that the indicia is still to be visible when a scriber interacts with the displayed portion of the target area; receiving scriber input at the target area; and enabling performance of a function associated with the target area based on the received scriber input.

In a third aspect, there is provided a computer program comprising computer code configured to enable the display of a portion of the target area and a corresponding indicium on a touch screen when a scriber is not interacting with the touch screen, the displayed portion of the target area being offset from the corresponding indicium such that the indicia is still to be visible when a scriber interacts with the displayed portion of the target area; enable the reception of scriber input at the target area; and enable the performance of a function associated with the target area based on the received scriber input.

The computer program may be stored on a recordable medium (e.g. DVD, CD, USB stick or other non-transitory computer-readable medium).

In a fourth aspect, there is provided apparatus comprising means for displaying a portion of a target area and a corresponding indicium on a touch screen when a scriber is not interacting with the touch screen, the displayed portion of the target area being offset from the corresponding indicium such that the indicia is still to be visible when a scriber interacts with the displayed portion of the target area; means for receiving scriber input at the target area; and means for enabling performance of a function associated with the target area based on the received scriber input.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 depicts a device configured to enable textual entry;

FIG. 2 depicts a further device configured to enable textual entry;

FIG. 3 depicts an embodiment comprising a number of electronic components; including memory; a processor and a communication unit;

FIG. 4 illustrates an embodiment with a touch screen and physical buttons;

FIG. 5a-5c illustrates views of the user interacting with the touch-screen as a user inputs a message;

FIG. 6 depicts the view of a touch screen; wherein the offset distance has been adjusted;

FIG. 7 illustrates a close up of a section of the virtual keyboard wherein the target area is larger than the portion of the target area displayed;

FIG. 8 depicts a close up of the virtual keyboard wherein the data representing the scriber input comprises a value corresponding to the proximity of the scriber to the displayed portion of the target area;

FIG. 9a-b depicts an embodiment to allow the user to intact with menu items;

FIG. 10 depicts a flow diagram describing the method used to enable the performance of a function associated with the target area; and

FIG. 11 illustrates schematically a computer readable medium providing a program according to an embodiment of the present invention.

### DESCRIPTION

For the sake of convenience, different embodiments depicted in the figures have been provided with reference numerals that correspond to similar features of other described embodiments. For example, feature number 1 can also correspond to numbers 101, 201, 301 etc. These numbered features may not have been directly referred to within the description of the particular embodiments. These have still been provided in the figures to aid understanding of the further embodiments, particularly in relation to the features of other described embodiments.

It is now not unusual for electronic devices to utilise touch screen technology to provide a user interface for enabling a user to interact with the device. Generally the touch screen displays one or a number of target areas, each target area occupying a part of the touch screen area and corresponding to a function. These functions may depend on the device and the mode of the device. For example, for a mobile phone in a text entry mode, the functions may include selecting letters for textual entry. For a laptop, the functions may include running an application.

In order for a user to indicate selection of a function using a touch screen (e.g. to select a letter for textual entry, a menu item and/or an icon), a user may touch the touch screen with a scriber. The scriber may be, for example, his finger, his finger nail or a stylus. Generally the region associated with the function (i.e. the target area) is denoted by an indicium (e.g. a label or marker) representing the function (that is, such that the user knows which region performs which function). For example, the key on a virtual keypad representing the letter ‘a’ may have an indicium at the centre of the key indicating that the key is associated with the letter ‘a’. This informs the user that, if he were to touch the key with the scriber, the letter ‘a’ would be entered. In this case, the key boundary denotes the position and extent of the target region whilst the indicium denotes the function of the target region. However, in such a scenario, as the user moves the scriber towards the key representing the letter ‘a’ the indicium/label is obscured. Therefore when the scriber is at the point of selecting the function associated with the key (or touch area), the user may not know which key has been pressed without looking at a different, removed location (for example, at the entered text display region of the screen).

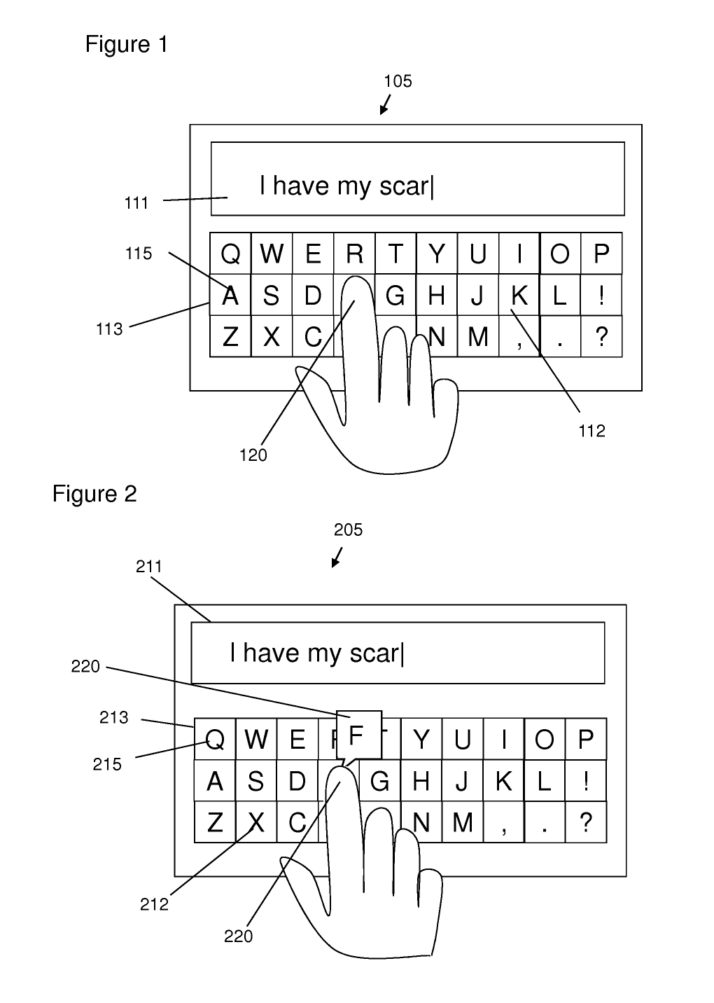

FIG. 1 illustrates the display screen of such a device when the device is in use. In this example, the user of the device wants to write a message comprising the phrase ‘I have my scarf’. To facilitate inputting such a message, this device has a text entry mode wherein the touch-screen (105) is divided into two regions. The bottom (keyboard) region (112) of the screen is where the user can select letters by pressing his finger (i.e. the user's finger (120) is the scriber in this example) on the screen. Each of the keys (113) represents the position and extent of a target area. That is, each respective target area is coterminous with the corresponding displayed key. The top (text entry) region of the screen (111) is configured to display the letters entered into the device using the scriber. The indicium (115) for each target area is located at the centre of the displayed portion of the target area (113). That is, the centre of the indicium and the centre of the corresponding displayed portion of the target area (113) are substantially in the same location. That is, the centre of the indicium and the centre of the corresponding target area are sufficiently close that the scriber could obscure both simultaneously.

For this device, when the user types using finger (120) input, the user tries to hit the centre of the key to ensure the greatest likelihood of correct input detection (that is, to avoid touching an adjacent key). As each indicium (115) associated with each displayed portion of the target area (or key) (113) is, in this case, also at the centre of the target area, when the user has touched the key to select it the user's finger (120) hides or obscures the character label (or indicium (115)) displayed on the key. The user may need to look at the far removed top (text entry) region (111) of the screen to view what has been input.

Alternatively, a device may be configured to allow the user to know which key is pressed, whilst it is being pressed, by generating additional indicia (e.g. pop-up labels) which are activated when, and only when, the scriber is in contact with the screen. This has the effect that the indicium denoting the letter (in the case of textual entry) appears to move as the key is selected. That is, when the indicium denoting the function of the key is obscured by the scriber, the indicium appears to be replaced by a second indicium positioned outside the scriber interaction region (i.e. the region of the touch screen which is in contact with the scriber). However, the additional indicia may obscure other non-activated keys making it difficult to anticipate where the subsequent keys are which the user may wish to activate. This may be a problem when the user is tapping out letters one-by-one, and particularly when the user is attempting to anticipate the subsequent keys he wishes to select.

FIG. 2 depicts a further example of a device configured to generate additional indicia, when the scriber interacts with the touch screen. As in the previous example for the previous device, the user of this device wants to write a message comprising the phrase ‘I have my scarf’. In this case the embodiment allows the user to know which key is being pressed by displaying an additional pop-up label/indicium (230) when the key is pressed (but not prior to the key being pressed). However this pop-up label may obscure other keys (213) of the keyboard (212) (as in this case where the letters ‘R’ and ‘T’ are at least partially obscured). If the user wished to type either of these keys after the pressed key, the user may have to remove the scriber (220) from the touch screen (205) and wait for the pop-up (230) to disappear before searching for the obscured letters.

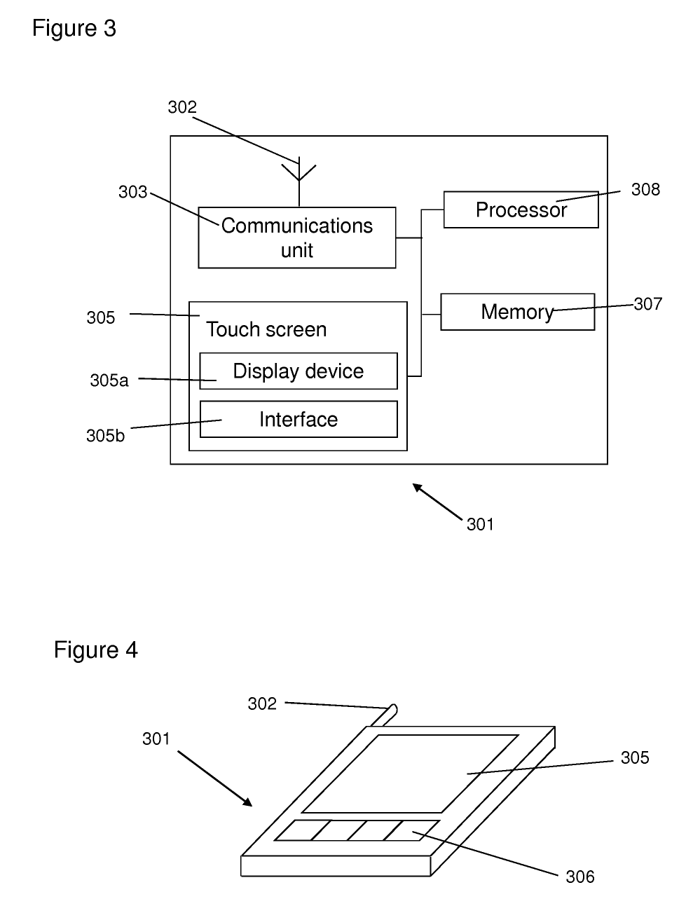

FIG. 3 depicts an example embodiment of an apparatus (301), such as a mobile phone or personal digital assistant, comprising a touch screen (305) such as, for example, a projected capacitive touch Screen. In other embodiments, the apparatus (301) may comprise a module for a mobile phone (or PDA or audio/video player), and may just comprise a suitably configured memory 107 and processor 108 (see below).

The apparatus (301) of FIG. 3 is configured such that it may receive, include, and/or otherwise access data. For example, the apparatus (301) may comprise a communications unit (303), such as a receiver, transmitter, and/or transceiver, in communication with an antenna (302) for connecting to a wireless network and/or a port (not shown) for accepting a physical connection to a network, such that data may be received via one or more types of networks. This embodiment comprises a memory (307) that stores data, possibly after being received via an antenna (302) or port or after being generated at the touch screen user interface (305b). The touch screen user interface allows the user to interact with one or more target areas to generate data representing scriber input (that is, scriber input is received at the touch screen from the scriber). The processor (308) may receive the data representing scriber input from the touch screen user interface (305b), from the memory (307), and/or from the communication unit (303). Regardless of the origin of the data, these data may be outputted to a user of apparatus (301) via a touch screen (305) display device (305a), and/or any other output devices provided with the apparatus. The processor (308) may also store the data for later use in the memory (307). The memory (307) may store computer program code and/or applications which may be used to instruct/enable the processor (308) to perform functions (e.g. generate, delete and/or process data). It will be appreciated that other embodiments may comprise additional displays (e.g. CRT screen, LCD screen and/or plasma screen) and/or user interfaces (e.g. physical keys and/or buttons). It will be appreciated that references to a memory or a processor may encompass a plurality of memories or processors.

FIG. 4 depicts an example of an outward appearance of the embodiment of FIG. 3 comprising a portable electronic device (301), e.g. such as a mobile phone, with a user interface comprising a touch-screen (305), a memory (not shown) and a processor (not shown). The user interface may further comprise a physical keypad (306) comprising buttons. The portable electronic device is configured to allow the user to interact with the portable electronic device with his/her finger on the touch screen (305). It will be appreciated that in other embodiments the user may interact with the touch screen using a stylus.

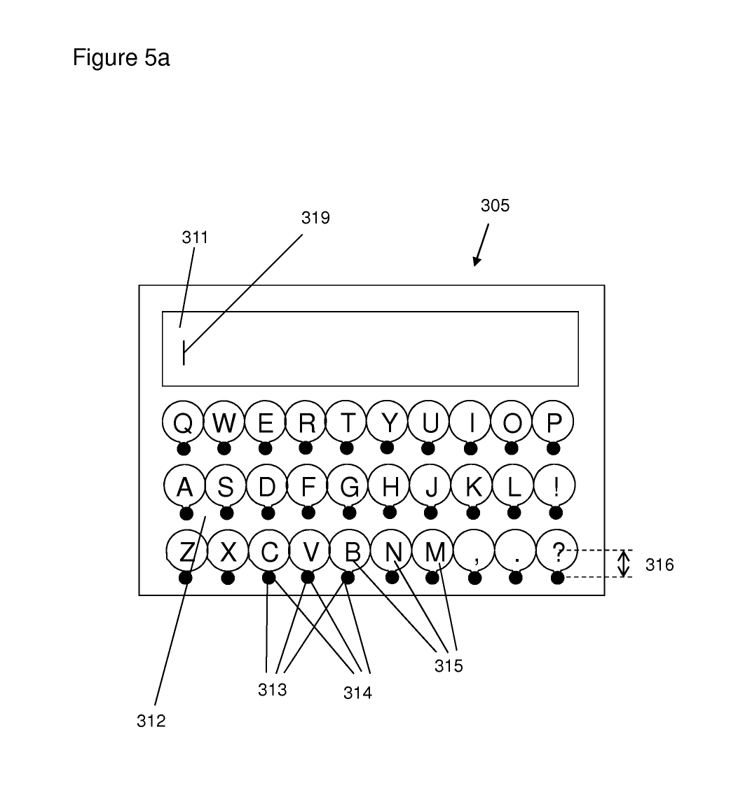

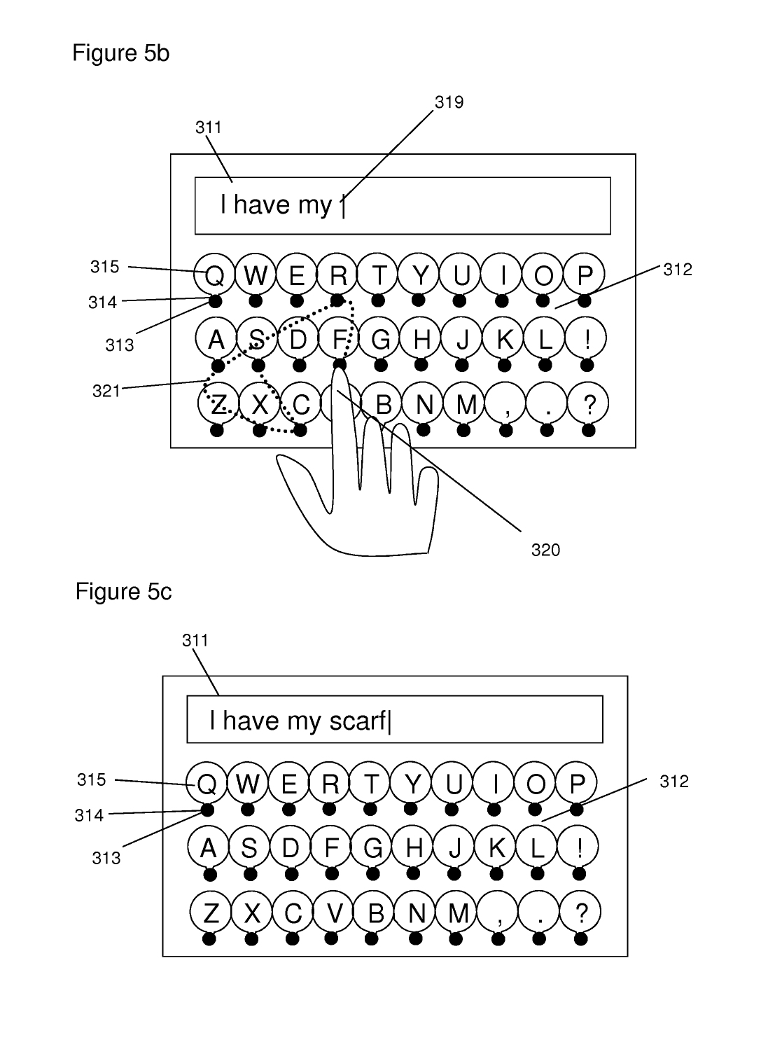

FIG. 5a illustrates an example embodiment of a display touch screen, such as display touch screen (305) of the embodiment of FIG. 4, when the scriber is not interacting with the screen. In this example (as previously), the user wants to write a message comprising the word ‘I have my scarf’ and send it, via a network (e.g. mobile phone network, internet, LAN or Ethernet), to a friend. To facilitate entering such a message, this embodiment has a text mode wherein the touch-screen (305) is divided into two regions. The bottom (keyboard) region (312) of the screen is where the user can select letters by moving his finger (i.e. the user's finger is the scriber in this example) across the touch screen (305). The bottom (keyboard) region (312) (or virtual keyboard) comprises a plurality of keys (in FIG. 5a the keys are depicted as black circles), each key representing a displayed portion of a target area (313). Each of the displayed portions of the target areas is spatially separate from the adjacent displayed portions of the target areas. In this case the displayed portion of the target area (313) represents the whole target area (314). In other embodiments the displayed portion may have a different extent to the whole target area. Therefore, for this embodiment, the user pressing the scriber onto the touch screen at the position of the indicia (or any other position not within the displayed portion of the target area (e.g. between keys)) will not correspond to scriber input at the target area. The keyboard (312) is arranged according to the standard QWERTY layout. It will be appreciated that the keys of a keyboard displayed by other embodiments may be arranged according to another layout (e.g. the Dvorak Simplified Keyboard layout).

The top (text entry) region of the screen (311) is configured to display the characters entered into the device. It will be appreciated that each key (or displayed portion of a target area) of a keyboard displayed by other embodiments may correspond to a plurality of functions (e.g. a single target area representing a plurality of letters, such as a key of a virtual ITU-T E.161 keypad for predictive text).

In this case the virtual keyboard comprises a set of keys (313) (i.e. displayed portions of respective target areas) representing the letters of the alphabet and a number of punctuation marks. In this case the embodiment is configured to display a portion of each of the target areas (313) and corresponding indicia (315) on the touch screen (305) when a scriber (320) is not interacting with the touch screen (305). Each displayed portion (313) of each target area is configured to be offset from and below the corresponding indicium (315) such that the indicium (315) is still to be visible when a scriber (320) interacts with the target area (314). The offset distance (316) is the distance between the centre (or edge perimeter) of the displayed portion of the target area (313) and the corresponding indicium (315). In this case the displayed portion (313) of the target area (314) represents the entire target area. That is, the target area (314) is coterminous with the displayed portion of the target area (313) (i.e. the displayed key). Each target area (314) is associated with a function. In this case the function of each target area is enabling selection of the corresponding character for textual entry. The indicia (315) indicate, to the user, which character corresponds to which target area (314) (and the function of each target area). In this example, some of the characters are letters from the Roman/Latin alphabet and some characters are punctuation marks. At the time depicted in FIG. 5b, user has already entered the words ‘I have my’ into the top (text entry) region (311) of the screen (305). A text indicator (319) indicates the position in the message where text will be added when subsequent text is entered.

It will be appreciated that in other embodiments, the apparatus will enable characters from other alphabets (e.g. Cyrillic or Greek alphabets) or numbers to be entered. It will be appreciated that this textual entry system may enable entering textual data into an electronic device (e.g. phone numbers, contact names, internet search terms, URLs) or composing textual messages (e.g. email, SMS messages, MMS messages, text messages).

For this embodiment, text entry is facilitated by generating scriber input at the touch screen corresponding to a contact action (321) (as shown in FIG. 5b) of the scriber across the touch screen (305). It will be appreciated that other embodiments may receive scriber input at the touch screen representing a non-contact action of the scriber close to the touch screen. The device (301) is configured to record the contact action (321) on the virtual keyboard (312). In this case, the contact action (321) includes an initial contact location, a path along which contact with the touch-sensitive screen continues, and a final contact location at which contact of the scriber with the touch-sensitive screen is removed, forming an input stroke pattern according to said recorded contact action. During the contact action, the scriber may come in contact with a series of one or more target areas (314). Data representing the scriber input corresponding to the contact action is received by the processor of the device (not shown).

FIG. 5b illustrates the configuration of the embodiment of FIG. 5a at the point in time when the user is just about to complete a contact action (321) for the word ‘scarf’. The contact action (321) is depicted by the dotted line and represents the position of the user's finger between initiating contact with the screen and the position as depicted in FIG. 5. The user's finger has come in contact with the target areas (314) associated with the letters ‘S’, ‘X’, ‘C’, ‘A’, ‘R’ and ‘F’ (in that order). In this case the scriber (320) (in this example, the user's finger) is interacting with the displayed target area (314) associated with the letter ‘F’. As the displayed portion of the target area (313) is offset from the indicium (315) corresponding to the target area (314), the user can confirm visually that he has selected the correct letter without having to move his finger (or having to remove his finger from the touch screen and thereby completing the contact action (321) or looking at the top (text entry) region (311)). The magnitude of the offset may be chosen such that it is appropriate to the scriber, for example, a small offset may be configured when it is expected that a slim stylus will be used as a scriber, and a larger offset may be configured when it is expected that a user's finger will be used as a scriber. This configuration may be performed by the manufacturer, who may intend his device for use with a particular scriber type. It will further be appreciated that, for this embodiment, if the user were to require further characters for this contact action (321) (e.g. to add a punctuation mark or additional letters), the user could search for the additional letters without having to lift his finger (320) from the touch screen (305). This is because, in this case, although the scriber is interacting with a target area (314) at an interaction region, the interaction region is removed from the indicia (315) labelling this and other target areas (314). The user can therefore, in this case, see all of the available target indicia and also, with some degree of co-ordination, also move his finger over the indicia (315) without actuating user input of the particular function.

FIG. 5c depicts the embodiment of FIG. 5b when the user has removed his (finger) scriber (320) from the screen. The device (301) detects that the contact action (321) is complete, for example when the device detects that the user removes his (finger) scriber (320) from the touch screen (305). In this embodiment, the device is configured to search the dictionary to find candidate words wherein the initial letter corresponds with the target area of the initial contact location; the final letter corresponds with the target area of the final contact location; and the order of the letters making up the word have the same order as at least some of the letters corresponding to the target areas touched during the contact action.

In this case, the apparatus is configured to search a dictionary (e.g. a predictive text dictionary stored in the memory (307)) for words corresponding to the letter sequence ‘S’, ‘X’, ‘C’, ‘A’, ‘R’, ‘F’, which has an initial letter ‘S’ and a final letter ‘F’ (the target area ‘X’ was touched due to limited user coordination). In this case only one word in the dictionary satisfies these criteria (i.e. the word ‘scarf’). As there is only one candidate word in this case, the candidate word is then entered automatically into the top (text entry) region (301) of the screen. It will be appreciated that if multiple candidate words were determined, the device may be configured to automatically enter the most probable candidate word or to allow manual selection by the user (e.g. via a pop up selection screen). In this way the performance of the functions associated with the target areas (314) (i.e. entering characters) is enabled for this embodiment.

It will be appreciated that other embodiments may use different criteria for determining which words in the dictionary correspond to the contact action. For example, the criteria may comprise analysing the order of the letters only, without specifying the initial or final letters (which would, for the above described contact action (321), generate a list of candidate words including ‘car’, ‘scar’ and ‘scarf’).

It will be appreciated that the methods described could be used in conjunction with error-detection and error-correction technologies to mitigate the effects of inadvertently activating the wrong key (e.g. dictionary based word-checking). It will be appreciated that some embodiments may allow the user to select target areas individually by, for example, tapping the corresponding target area.

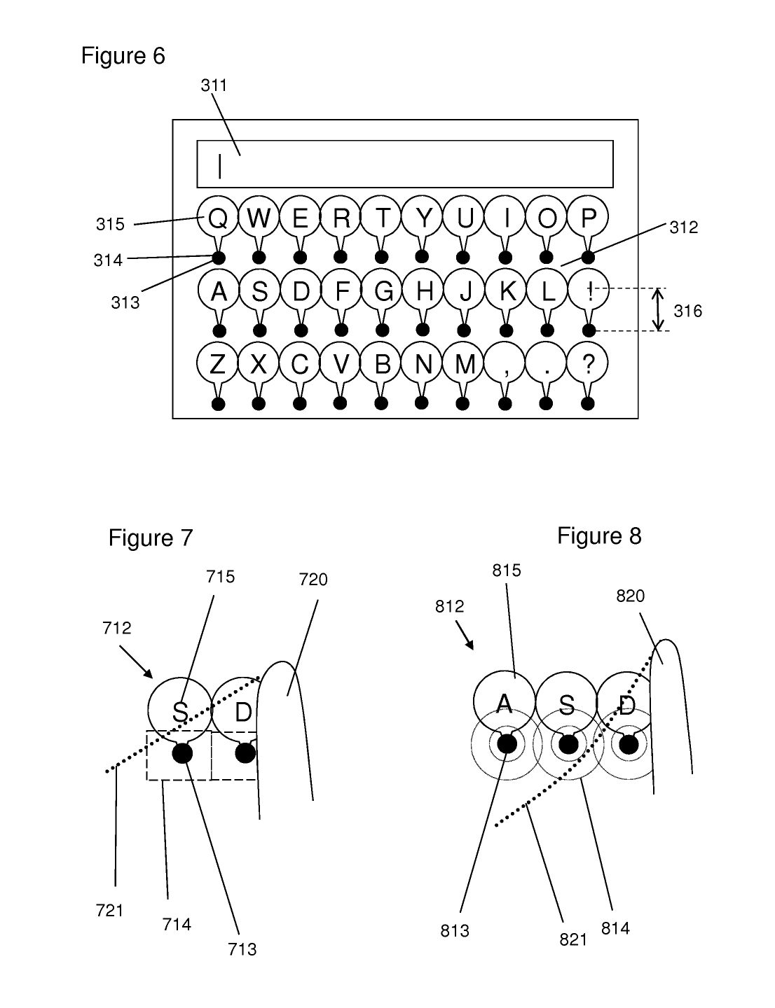

FIG. 6 depicts a further example of the embodiment of FIG. 4, wherein the offset distance (316) has been increased. In this case the apparatus is configured to detect the size of the scriber (or user's finger) and adjust the offset distance (316) of the indicia from the displayed portion of the target area automatically. This embodiment is configured to have a default offset as depicted in FIG. 4. It will be appreciated that for other embodiments, the offset distance (316) and/or direction may be set manually. The offset may be chosen such that in normal use the user can see a portion (for example a majority) of the target indicia, the portion large being enough for the user to determine from the indicia the function associated with the target area.

FIG. 7 depicts a close up of the bottom (keyboard) region (712) of the screen of a further embodiment. Unlike the previous embodiment wherein the displayed portion of the target area (313) represented the entire target area (314) (i.e. wherein the target area and the displayed portion of the target area were coterminous), in this embodiment, the displayed portion of the target area (713) represents only a part of the entire target area (714) (that is, the part of the target area which is displayed is less than the whole of the actual target area which will receive input). The target area (714) is, in this case, therefore larger than the portion (713) displayed. In this embodiment, the displayed portion of the target area (713) is at the centre of the target area (714) and serves to give the user a position to aim the scriber at to select the key. It will be appreciated that for other embodiments the displayed portion of the target area may not be the centre portion of the target area. Nevertheless, for this embodiment, if the user misses the displayed portion (713) (as depicted in FIG. 7), the scriber could fall within the non-displayed portion of the target area such that the target area (714) would be selected in the same way as if the user had touched the scriber to the displayed portion of the target area (713). That is, as in this example, although the user did not touch the displayed portion, he/she did touch the target area which generates corresponding scriber input.

FIG. 8 depicts a close up of a section of the bottom (keyboard) region (812) of the touch screen of a further embodiment. Like the previous case, only a part of the target area (813) is displayed. However, in this embodiment, the apparatus is configured to assign a selection probability to a function based on the proximity of the scriber input to the displayed portion of the corresponding target area (814). In this example, the user has entered a contact action (821) (via the scriber), the path of which is proximate to the displayed portion of the target areas (813) associated with the letters ‘S’ and ‘D’. However, the path of the contact action approaches the displayed portion of the target area (813) corresponding to the letter ‘S’ more closely than that of the letter ‘D’. In this embodiment, when the contact action is complete and the processor processes which words correspond to the entered contact action, the apparatus is configured to assign a greater probability to words containing letters which are approached more closely. In this example, the letter ‘S’ would be assigned a higher probability than the letter ‘D’.

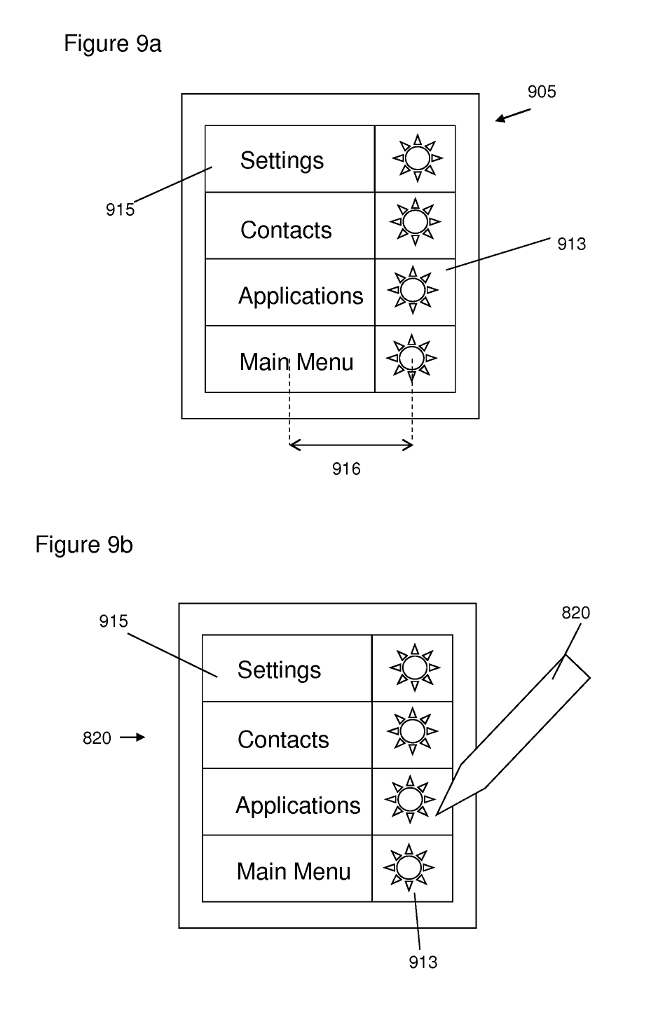

FIG. 9a depicts the screen of a further embodiment, for example a smartphone. This embodiment is configured to allow the user to navigate a series of menus to access different functionalities of the phone. For this embodiment the scriber is a stylus (920). FIG. 9 depicts a selection of menu items. Each menu item has an associated function. For example, selecting the ‘Applications’ menu will open a list of applications, selecting the ‘contacts’ menu will open a list of contacts. Each menu item function has a corresponding target area, a portion of which (913) is displayed. In this embodiment the displayed portion (913) of the target area represents the whole target area. Each menu item function also has a corresponding indicium (915). Each indicium comprises textual information indicating/denoting the nature of the function corresponding to the corresponding target area. It will be appreciated that in other embodiments the indicia may comprise pictorial representations of the corresponding functions. For each menu item function the corresponding indicium is offset (or displaced) laterally from (or to the side of) the corresponding displayed portion of the target area by an offset distance (916). In this case the offset distance is the distance between the centre of the displayed portion of the target area and the corresponding indicia. In this case each indicium (915) is displayed contiguous with the respective corresponding displayed portion of the target area (913).

FIG. 9b depicts the user selecting the ‘Applications’ menu item function. The user does this by placing the scriber (920) tip (which in this case is a stylus) within the target area represented by the displayed portion of the target area (913). From the interaction of the scriber at the touch screen (or scriber input received), the touch screen (905) generates data representing scriber input at the target area. This scriber input is received by the processor (not shown). The scriber input, for this embodiment, includes the positions of the touch screen touched by the scriber and the associated target areas. The processor processes which function is associated with the touched target area and performs that function. In this example, the touched target area corresponds to the function of opening the ‘Applications’ menu.

This embodiment is also configured to receive scriber input at the indicium and enable performance of a function associated with the indicium based on the received scriber input. Therefore, in this case, the user could touch the scriber at the indicium corresponding to the ‘Applications’ menu item to activate the corresponding function (i.e. open the applications menu). It will be appreciated that in other embodiments the indicium may not be able to receive scriber input.

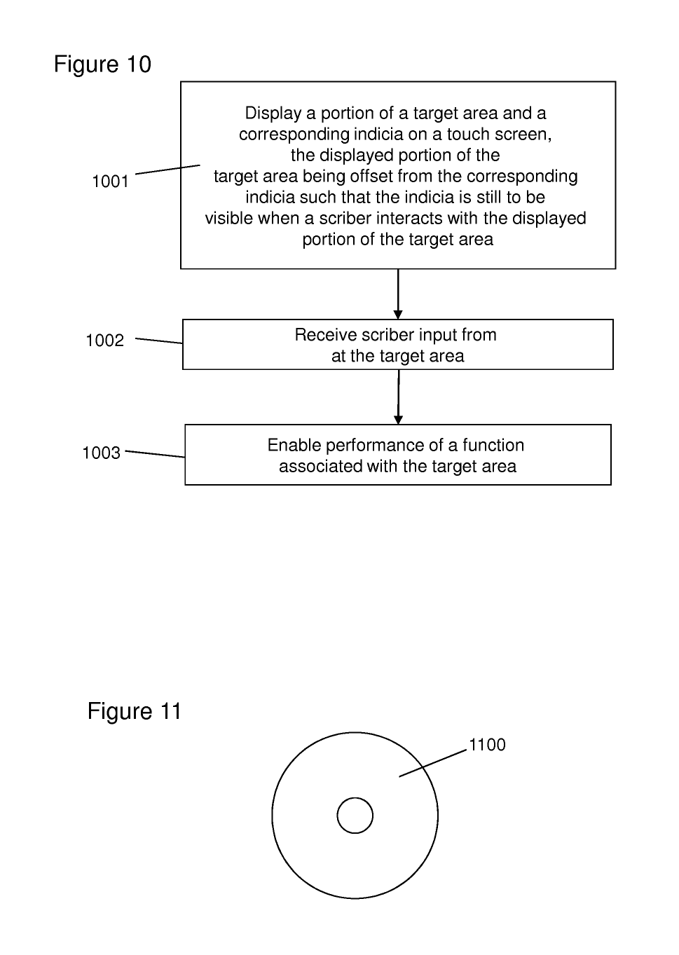

FIG. 10 shows a flow diagram illustrating how a performance of a function, associated with a target area and having a corresponding offset indicia, is enabled by scriber input.

FIG. 11 illustrates schematically a computer/processor readable media 1100 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. An apparatus comprising:
at least one processor; and
at least one memory including computer program code,
the at least one memory and the computer program code configured to, with the at least one processor, cause the apparatus to perform the following:
display a portion of a target area and a corresponding indicium on a touch screen when a scriber is not interacting with the touch screen, the displayed portion of the target area being offset from the corresponding indicium such that the indicia is still to be visible when a scriber interacts with the displayed portion of the target area;
receive scriber input at the target area; and
enable performance of a function associated with the target area based on the received scriber input.

2. The apparatus of claim 1, wherein the apparatus is configured such that the respective target areas/indicia provide for scriber input of characters, with the indicia indicating the particular character which can be input.

3. The apparatus of claim 1, wherein the display comprises a plurality of target areas and corresponding indicia, and wherein the apparatus is configured such that the respective target areas/indicia provide for scriber input of characters, with the each indicia indicating the particular character which can be input.

4. The apparatus of claim 1, wherein the display comprises a plurality of target areas and corresponding indicia, and wherein the apparatus is configured such that the respective target areas/indicia represent an alphanumeric key input area.

5. The apparatus of claim 1, wherein the apparatus is configured such that the respective target areas and/or indicia provide for scriber input indicating the selection of an item from a menu, with the indicia indicating the particular item from the menu which can be selected.

6. The apparatus of claim 1, wherein the apparatus is configured such that the respective target areas and/or indicia provide for scriber input indicating the selection of an icon relating to an application, with the indicia indicating the particular icon relating to an application which can be selected.

7. The apparatus of claim 1, the apparatus configured to:
receive scriber input at the indicia; and
enable performance of a function associated with the indicia based on the received scriber input.

8. The apparatus of claim 1, the apparatus configured to:
associate a target area of a touch screen with each of one or more target functions, the touch screen configured to generate data in response to the scriber input.

9. The apparatus of claim 1 wherein the target indicium is displayed contiguous with the respective target area.

10. The apparatus of claim 1 wherein a series of target functions can be selected by contacting the screen with the scriber in one continuous motion, wherein, during the continuous motion, the scriber touches each of the target areas corresponding to the series of target functions.

11. The apparatus of claim 1 wherein the target area and corresponding indicium are configured to be spatially distinct such that a scriber can interact with the touch screen at the corresponding indicium without inputting the function associated with the corresponding indicium.

12. The apparatus of claim 1 wherein the apparatus is configured to enable adjustment of the offset.

13. The apparatus of claim 1 wherein the electronic device is a portable electronic device, a laptop computer, a desktop computer, a mobile phone, a Smartphone, a monitor, a personal digital assistant or a digital camera.

14. A method comprising:
displaying a portion of a target area and a corresponding indicium on a touch screen when a scriber is not interacting with the touch screen, the displayed portion of the target area being offset from the corresponding indicium such that the indicia is still to be visible when a scriber interacts with the displayed portion of the target area;
receiving scriber input at the target area; and
enabling performance of a function associated with the target area based on the received scriber input.

15. A method of claim 14, wherein the respective target areas/indicia provide for scriber input of characters, with the indicia indicating the particular character which can be input.

16. The method of claim 14, wherein the display comprises a plurality of target areas and corresponding indicia, and wherein the respective target areas/indicia provide for scriber input of characters, with the each indicia indicating the particular character which can be input.

17. The method of claim 14, wherein the display comprises a plurality of target areas and corresponding indicia, and wherein the respective target areas/indicia represent an alphanumeric key input area.

18. The method of claim 14, wherein the respective target areas and/or indicia provide for scriber input indicating the selection of an item from a menu, with the indicia indicating the particular item from the menu which can be selected.

19. The method of claim 14, wherein the respective target areas and/or indicia provide for scriber input indicating the selection of an icon relating to an application, with the indicia indicating the particular icon relating to an application which can be selected.

20. The method of claim 14, further comprising:
receiving scriber input at the indicia; and
enabling performance of a function associated with the indicia based on the received scriber input.

21. The method of claim 14, the method further comprising:
associating a target area of a touch screen with each of one or more target functions, the touch screen configured to generate data in response to the scriber input.

22. The method of claim 14, further comprising displaying the target indicium contiguous with the respective target area.

23. The method of claim 14 wherein a series of target functions can be selected by contacting the screen with the scriber in one continuous motion, wherein, during the continuous motion, the scriber touches each of the target areas corresponding to the series of target functions.

24. The method of claim 14 wherein the target area and corresponding indicium are configured to be spatially distinct such that a scriber can interact with the touch screen at the corresponding indicium without inputting the function associated with the corresponding indicium.

25. The method of claim 14, wherein adjustment of the offset is enabled.

26. Computer program, comprising computer code configured to:
enable the display of a portion of a target area and a corresponding indicium on a touch screen when a scriber is not interacting with the touch screen, the displayed portion of the target area being offset from the corresponding indicium such that the indicia is still to be visible when a scriber interacts with the displayed portion of the target area;
enable the reception of scriber input at the target area; and
enable the performance of a function associated with the target area based on the received scriber input.
